(19) United States
(12) Patent Application Publication
(10) Pub. No.: US 2026/0205220 A1
(43) Pub. Date: Jul. 16, 2026

(54) Selecting a Best Available Precision Time Protocol (PTP) Backup when a Global Navigation Satellite System (GNSS) Clock Source is Unavailable

(71) Applicant: Ciena Corporation, Hanover, MD (US)

(72) Inventors: Sharad Kumar Srivastava, Varanasi (IN); Ankur Saxena, Bangalore (IN)

(73) Assignee: Ciena Corporation, Hanover, MD (US)

(21) Appl. No.: 19/063,979

(22) Filed: Feb. 26, 2025

(30) Foreign Application Priority Data
Jan. 14, 2025 (IN) 202511003167

(51) Int. Cl. H04J 3/06; H04W 56/00

(52) U.S. Cl. CPC H04J 3/0667; H04W 56/001

(57) ABSTRACT

Systems and methods for selecting a backup clock source are provided. In one implementation, a method includes a step of obtaining multiple data sets representing multiple backup clocks in a communications network. The method further includes a step of analyzing offset characteristics of the multiple backup clocks in order to select a substitute clock source from the multiple backup clocks to operate as a temporary substitute when a primary source of synchronization for the communications network is unavailable. For each backup clock, the offset characteristics are related to a synchronization offset of the associated backup clock with respect to the primary source.

### FIELD OF THE DISCLOSURE

The present disclosure relates generally to time synchronization in communication networks. More particularly, the present disclosure relates to systems and methods for enhancing holdover in a Precision Time Protocol (PTP) network by selecting a best available PTP backup source when a Global Navigation Satellite System (GNSS) time source is unavailable.

### BACKGROUND

The Standardization Sector of the International Telecommunications Union (ITU) has published a number of Recommendations regarding time and phase synchronization in telecommunications networks. In particular, this family of synchronization standards includes ITU-T Recommendations G.8271, G.8271.1, G.8271.2, G.8272, G.8272.1, G.8272.2, G.8273, G.8273.2, G.8273.3, G.8273.4, G.8275, G.8275.1, G.8275.2, among others, plus amendments thereto. In addition, the Institute of Electrical and Electronics Engineers (IEEE) has published versions of a Precision Time Protocol (PTP) in IEEE 1588 (i.e., IEEE 1588-2002, 1588-2008, 1588-2019) defining clock synchronization in communication networks. The content of these synchronization recommendations, protocols, and standards are incorporated by reference in the present disclosure.

### BRIEF SUMMARY

The present disclosure relates to systems and methods for enhancing time holdover in a Precision Time Protocol (PTP) network. According to one implementation, a process for selecting a backup clock source includes a step of obtaining multiple data sets representing multiple backup clocks. In response to detecting that a primary source of synchronization for the communications network is unavailable, the process further includes a step of analyzing offset characteristics of the multiple backup clocks in order to select a substitute clock source from the multiple backup clocks to operate as a temporary substitute for the primary source. For each backup clock, the offset characteristics are configured to be related to a synchronization offset of the associated backup clock with respect to the primary source.

According to additional embodiments, each of the multiple data sets may include data points representing the synchronization offset of the associated backup clock with respect to the primary source over time. For example, the data points of each of the data sets may be plottable as a waveform. Also, a variability factor may be defined as a peak-to-peak value of the associated waveform. In this case, it is compared with the variability factor of other data sets to select the substitute clock source from a backup clock of the multiple backup clocks having the lowest peak-to-peak value. In alternative embodiments, the variability factor may be defined as an average value or median value of the associated waveform. In this case, it is compared with the variability factor of other data sets to select the substitute clock source from a backup clock of the multiple backup clocks having the lowest average value or median value.

In some embodiments, each of the multiple data sets may include data points representing the synchronization offset of the associated backup clock with respect to the primary source over a most recent time period of predetermined length. For example, the predetermined length may be about 24 hours. Before detecting that the primary source is unavailable, the process may further include a step of continuously calculating the offset characteristics to determine, substantially in real-time, a best clock source selection for operation as the substitute clock when the primary source is unavailable.

The multiple backup clocks, for example, may include two or more Precision Time Protocol over Internet Protocol (PTP over IP) sources. The communications network associated with the process may include at least a mobile network having radios, Base Band Units (BBUs), eNodeB components, towers, satellites, etc. The primary source of synchronization, as described herein, may be a clock reference from a Global Navigation Satellite System (GNSS). In some embodiments, selection of the substitute clock source may be an enhancement to one or more standards or protocols defined in IEEE 1588, Precision Time Protocol (PTP), ITU-T recommendations regarding clock synchronization, and/or ITU-T recommendations regarding Assisted Partial Timing Support (APTS). Also, in some cases, a network element that implements the process may be a Telecom-Boundary Clock-Assisted (T-BC-A) device having multiple servos configured to receive the multiple data sets.

### BRIEF DESCRIPTION OF THE DRAWINGS

The present disclosure is detailed through various drawings, where like components or steps are indicated by identical reference numbers for clarity and consistency.

FIG. 1 is a diagram illustrating a system for improving holdover of a PTP network, according to various embodiments.

FIG. 2 is a diagram illustrating another system for improving holdover in an APTS network, according to various embodiments.

FIG. 3 is a diagram illustrating another system for improving holdover in an APTS network, according to various embodiments.

FIG. 4 is a graph illustrating an example of offset characteristics (in ns) over time with respect to a primary time reference, such as a local time reference, GNSS time source, GPS time source, etc.

FIG. 5 is a flow diagram illustrating a process that represents an enhancement to a BTCA described in various synchronization standards and protocols, according to various embodiments.

FIG. 6 is a block diagram illustrating a network element configured to operate in a communications network, which may include a mobile or cellular system, according to various embodiments.

FIG. 7 is a flow diagram illustrating a method for selecting a backup clock source, according to various embodiments.

### DETAILED DESCRIPTION

In a packet network, a switch (also referred to herein as a node) uses the Precision Time Protocol (PTP) to achieve timing synchronization by exchanging timestamped packets with PTP masters and slaves in the network. The protocol ensures accurate synchronization of clocks across network elements by compensating for delays introduced by packet transmission. The switch acts as either a PTP boundary clock or a PTP transparent clock, where boundary clocks synchronize with an upstream source and distribute timing downstream, while transparent clocks measure and correct for delay variations within the network. In particular, this precise timing is critical in 5G applications, where Ultra-Reliable Low-Latency Communication (URLLC), Time-Sensitive Networking (TSN), and massive Machine-Type Communications (mMTC) demand highly accurate synchronization to meet stringent latency and jitter requirements.

Timing in these networks originates from Primary Reference Clocks (PRCs), which are highly stable and accurate clock sources compliant with ITU-T standards, such as those described herein. PRCs typically derive their timing from atomic clocks or Global Positioning Satellite (GPS) systems, providing the foundation for network-wide synchronization. Secondary Synchronization Units (SSU-A clocks) act as intermediate timing sources that maintain synchronization during short interruptions in PRC availability. These clocks, designed with holdover capabilities, ensure continuity and accuracy of timing even in challenging scenarios, whereby “holdover” refers to a time period between synchronization events. Together, PTP-enabled switches, PRCs, and SSU-A clocks enable the precise timing required for the seamless functioning of advanced 5G networks.

The duration a node can remain in holdover is directly determined by the quality of its frequency source. A node with a clock traceable to a PRC will typically exhibit slower time deviation compared to one relying on an SSU-A clock, which is less stable. In scenarios where two interconnected nodes lose connectivity to the Grandmaster Clock (GMC), the network protocol dictates that one node assumes the role of Master while the other becomes a Slave. The Slave node synchronizes with the Master and thus inherits the same rate of deviation as the Master. However, challenges arise when the node selected as the Master does not have a robust frequency backup and deviates rapidly. In such a case, even the Slave node, despite having a better frequency source, would deviate at the same accelerated rate as the Master, leading to suboptimal network synchronization. This issue is a direct consequence of the Best time Transmitter Clock Algorithm (BTCA) defined in ITU-T G.8275.2, Amendment 1. The BTCA selects the Master based on predefined criteria, which may not always account for the quality of the frequency backup, potentially compromising the stability and accuracy of the overall network timing during holdover.

IEEE 1588 defines PTP, enabling precise synchronization of clocks across networked devices with sub-microsecond accuracy. The standard outlines the mechanisms for clock synchronization, including the exchange of timestamped messages and the BTCA algorithm for selecting the optimal clock within a network. The 2019 revision of IEEE 1588 (i.e., IEEE 1588-2019) introduces enhancements like improved accuracy, robustness against network delays, and security features to protect against timing attacks. A grandmaster clock in a PTP network serves as the primary source of accurate time for all devices within that network. It is the topmost clock selected through the BTCA algorithm, which assesses all clocks based on criteria like priority levels, clock class, accuracy, and stability to determine the most qualified one. Once designated, the Grandmaster clock distributes its precise time information to subordinate clocks by sending timestamped messages, ensuring that all devices are synchronized.

In mobile networking, the Global Navigation Satellite System (GNSS) can be used as a primary source for synchronization. Utilizing GNSS to synchronize radios and Base Band Units (BBUs) at a cell site has been a common method in mobile networks. It should be noted that there is a need for suitable network engineering practices to enable synchronization via transport network demands. However, with the evolution of the 5G, it has been discovered that using only GNSS clocks is not a legitimate solution to synchronize a network, specifically since the GNSS is subject to changes due to atmospheric conditions.

### Synchronization Recovery

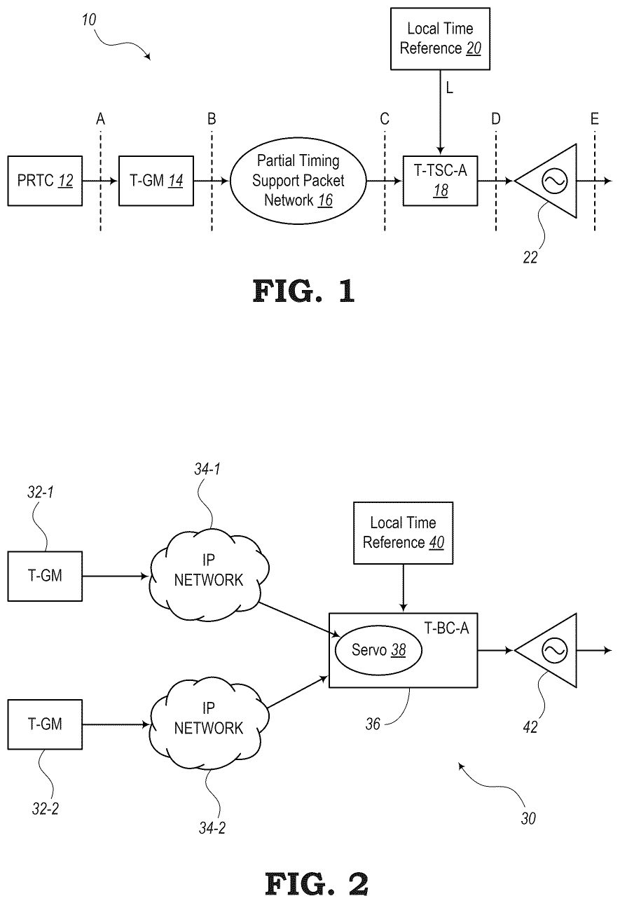

FIG. 1 is a diagram illustrating an embodiment of a system 10 for improving holdover of a PTP network. The system 10 may be similar to an example in ITU-T Recommendation G.8271.2 for addressing network limits for deployment in an Assisted Partial Timing Support (APTS) network. APTS, as defined in ITU-T Recommendation G.8275.2, provides a method allowing operators to use GNSS as a primary source, while a PTP over IP can be used as a backup when the primary source is unavailable. In APTS, when GNSS is used as an active source of synchronization, PTP is kept as a backup which keeps calculating its offset from the GNSS and compensates the offset in case of GNSS failure. It is to be noted that PTP over IP network is prone to Packet Delay Variation (PDV) due to the intermediate IP network. Hence, proper network engineering techniques are needed to ensure time delivery via the PTP packets over the IP network.

The system 10 includes a Primary Reference Time Clock (PRTC) 12 (e.g., Primary Reference Clock (PRC), Primary Reference Source (PRS), etc.), a Telecom-Grandmaster (T-GM) 14, a Partial Timing Support (PTS) packet network 16, a Telecom-Time Slave Clock-Assisted (T-TSC-A) 18, a local time reference 20 (e.g., a GNSS), and an end application 22.

The PTP network of the system 10 calculates its offset based upon the matrices given in standard as follows

| max\|pktSelected2wayTE\| | <100 | ns |
|---|---|---|
| Selection window | 200 | s |
| Selection percentage | 0.25% | |
| Selection method | percentile average packet selection (e.g., clause | |
| | I.3.2.2 of ITU-T Recommendation G.8260) | |
| Window step size | ≤20 | s |

The clock type T-BC-A (Telecom-Boundary Clock-Assisted) is targeted for the APTS scenario described in ITU-T Rec. G.8271.2, where the PTP input is used only as a secondary source of synchronization to hold the time for up to 72 hours. However, it should be noted that the PTP input is not necessarily intended to be used as the primary timing source unless GNSS goes down.

In some respects, there may be issues with conventional ways of selecting the PTP backup in APTS networks. As per the standards, in an APTS configuration, GNSS is also considered as the PTP virtual port and participates in the BTCA algorithm as a regular PTP clock source. Consider a case of APTS where multiple PTP sources are ready to provide a backup to the active GNSS source in case of failure, as described below.

### Holdover Enhancement Systems in Assisted Partial Timing Support (APTS) Network

FIG. 2 is a diagram illustrating an embodiment of a system 30 for improving holdover in an APTS network. In this embodiment, the system 30 includes a first T-GM 32-1 and a second T-GM 32-2 connected to a first IP network 34-1 and second IP network 34-2, respectively. The system 30 also includes a T-BC-A 36 that includes a servo 38, a local time reference 40 (e.g., GNSS), and an end application 42. When the primary synchronization source, such as the local time reference 40 is unavailable, the servo 38 of the T-BC-A 36 is configured to take the PTP source from the first IP network 34-1.

In this example, there are two PTP clock sources available to be used as the backup for the local (e.g., GNSS) source. The T-BC-A 36 is configured to select the best PTP source as its backup to the local GNSS decided by a BTCA algorithm. When a PTP is decided to be used as the backup to the GNSS, it feeds the timestamp to the servo 38. The servo 38 keeps calculating the offset of the PTP with respect to the GNSS source of the local time reference 40 and applies it when GNSS is failed or otherwise unavailable.

In an APTS network, it should be noted that asymmetry or offset from GNSS, as calculated by PTP, continues to vary due to the dynamic PDV introduced by the IP intermediate packet networks. With the current standards, BTCA selects the PTP source as the backup based upon a standard algorithm. However, current standards do not consider this asymmetry or offset variation, which are introduced by the systems and methods of the present disclosure, as described herein. Therefore, in the case of multiple PTP sources in the embodiment of FIG. 2, without consideration of the asymmetry variation of the PTP input in its selection algorithm, the system 30 may select a backup PTP source that has a higher asymmetry or offset variation than others. Therefore, further improvements in synchronization are described herein.

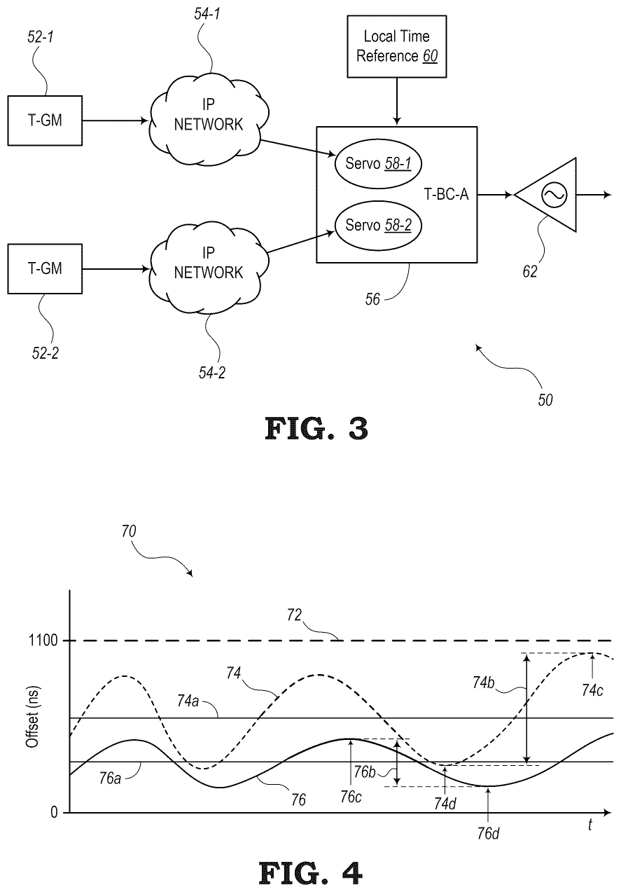

FIG. 3 is a diagram illustrating an embodiment of a system 50 for improving holdover in an APTS network. In this embodiment, the system 50 includes a first T-GM 52-1 and a second T-GM 52-2 connected to a first IP network 54-1 and second IP network 54-2, respectively. The system 50 also includes a T-BC-A 56 which includes a first servo 58-1 and a second servo 58-2. The system 50 also includes a local time reference 60 (e.g., GNSS) and an end application 62. When the primary synchronization source, such as the local time reference 60 is unavailable, the servos 58-1, 58-2 of the T-BC-A 56 are configured to receive and analyze the PTP sources from the first and second IP networks 54-1, 54-2, respectively. Based on current data (e.g., over the last 24 hours), the T-BC-A 56 is configured to analyze the PTP sources to determine which demonstrates the best characteristics with respect minimal asymmetry or offset variation.

Thus, the T-BC-A 56 in this system 50 is configured to provide an additional step of comparing two or more available backup PTP sources and selecting one that exhibits the lowest offset variation. For example, the T-BC-A 56 may be configured to operate as follows:

1) In the APTS configuration, both the PTP sources (from IP networks 54-1, 54-2, etc.) will provide the timestamps to their respective servo instances (e.g., servos 58-1, 58-2, etc.) and both the servo instances can calculate its offset with respect to the local time reference 60 (e.g., GNSS source) independently.

2) Asymmetry values for the two (or more) PTP inputs can be measured on the runtime against the selected GNSS. For example, its peak-to-peak variation can be recorded over 24 hours.

3) Even if both the servo instances are able to lock in monitor mode when GNSS is active, the BTCA can be slightly changed. For example, according to the various embodiments of the present disclosure, the BTCA may be configured to consider which of the PTP backups would be the best one with respect to minimal offset. That is, the BTCA can select the PTP backup source that has the lower offset variation with respect to the local GNSS over a certain amount of time (e.g., the last 14 hours).

### Graph of Synchronization Offset Characteristics

FIG. 4 is a graph 70 illustrating an example of offset (in ns) from a primary time reference (e.g., local time reference 60, GNSS time source, GPS time source, etc.) over time. It may be noted that the x-axis may represent the most current time measurements (e.g., over the last 24 hours), where values may be stored in a FIFO type of memory to only utilize the most recent offset values. A cutoff point 72 shows a limit of 1100 ns, which is an upper limit that indicates when an offset is too great and cannot be considered as reliable. In other words, the lower the offset value, the more accurate the backup source is and the exceeding or coming close to the cutoff point 72 is undesirable.

The graph 70 shows an example of two backup sources being compared. In other embodiments, more than two backup sources may be plotted on the graph 70 and compared for consideration as a selected backup source. A first plot 74 shows the offset characteristics of a first backup source (e.g., from the first IP network 54-1) and a second plot 76 shows the offset characteristics of a second backup source (e.g., from the second IP network 54-2).

The graph 70 gives a sense of the variation of the two PTP sources and how they vary with respect to the local GNSS for 24 hours. From this example shown in graph 70, a comparison of the two plots 74, 76 would indicate that the second backup source (i.e., associated with the second plot 76 has a smaller offset from the primary clock and could be selected for backup before selecting the first backup source. That is, the second backup source has a lower variation of offset with respect to the local GNSS and is therefore more stable than the first backup source. Also, the graph 70 shows that the second backup source has less of a chance of crossing the cutoff point 1100 ns when the system switches to the second backup source after failure of the local time reference 60 (or GNSS).

Certain offset characteristics can be obtained from the graph 70. For example, average values 74a, 76a of the first and second plots 74, 76, respectively, can be calculated. In some embodiments, peak-to-peak values 74b, 76b of the first and second plots 74, 76, respectively, can be calculated. For example, the peak-to-peak value 74b for the first plot 74 may be calculated by observing the last peak 74c and the last valley 74d, while the peak-to-peak value 76b for the second plot 76 may be calculated by observing the last peak 76c and the last valley 76d. Since the peak-to-peak value 76b of the second plot 76 is smaller than the peak-to-peak value 74b of the first plot 74, the second backup PTP source would be selected in this embodiment.

Process for Enhancing Best timeTransmitter Clock Algorithm (BTCA)

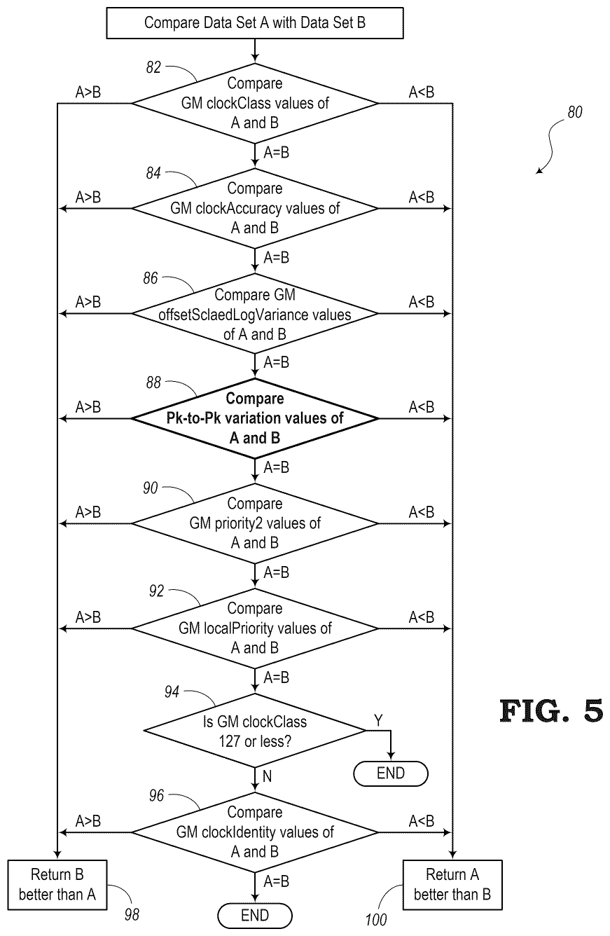

FIG. 5 is a flow diagram of a process 80 that represents an enhancement to the BTCA as described in various synchronization standards and protocols. For example, in addition to regular BTCA steps, the process 80 of FIG. 5 further includes a step of comparing peak-to-peak offset values of one source versus another, which may involve analysis of the results of a graph, such as the graph 70 of FIG. 4. The process 80 may be implemented by any node in the networks 10, 30 50 when there is a need to select a new time transmitter. That is, the process 80 contemplates implementation as a method with steps, via circuitry configured to implement the steps, and as a non-transitory computer-readable medium storing instructions that, when executed, enable or cause circuitry to implement the steps.

The process 80 can be used by a node to select a time transmitter based on two (or more) data sets, referred to in this example as Data Set A and Data Set B, each of which corresponds to the attributes of two distinct clocks being compared to determine the Best Time Transmitter (BTT). These data sets may be constructed from parameters extracted from the PTP Announce messages exchanged between clocks in the network 10, 30, 50. The algorithm ensures systematic evaluation of the two (or more) clocks to select the optimal timing source, essential for maintaining synchronization accuracy and stability.

The process 80 may be configured to compare various points in the data sets A and B and selects either A or B at each step based on a comparison, or it can move to the next step if the values are equal (or substantially equal). First, the process 80 compares the Grandmaster (GM) clockClass values of the data sets A and B, as indicated in decision block 82 and selecting the lower value or moving to the next step if the values are equal. That is, the lower GM clockClass value indicates the better clock. The GM clockClass values indicate a clock's traceability and stability, reflecting its synchronization quality and reliability within the network 10, 30, 50.

Next, the BTCA process 30 compares the GM clockAccuracy values of the data sets A and B, as indicated in decision block 84, selecting the lower value or moving to the next step. Also, the lower GM clockAccuracy value indicates the better clock. The GM clockAccuracy values specify the precision of a clock's timekeeping relative to a reference standard, indicating how closely the clock's time aligns with the true time. Next, the process 80 compares the GM offsetScaledLogVariance values of the data sets A and B, as indicated in decision block 86, selecting the lower value or moving to the next step. The GM offsetScaledLogVariance values quantify a clock's stability by measuring the variance of its time offset, providing insight into its precision and frequency consistency over time.

The present disclosure introduces a new step in the conventional BTCA. The process 80, in this embodiment, includes a step of comparing the peak-to-peak offset variation values of the data sets A and B, as indicated in decision block 88, and selecting the lower value or moving the next step. The step of comparing peak-to-peak offset variation values may be performed in the same or similar way as described with respect to the analysis of the graph 70 of FIG. 4, or other similar graph showing offset variation values over a recent time period (e.g., most recent 24 hours). Again, the lower peak-to-peak variation indicates the better clock.

Next, the process 80 compares the GM priority2 values of the data sets A and B, as indicated in block 90, and selecting the lower value or moving to the next step. The GM priority2 values are a user-configurable parameter that provides a secondary level of priority for clock selection, allowing network administrators to influence the BTCA by assigning values between 0 and 255, where lower numbers indicate higher priority. Next, the process 80 compares the GM localPriority values of the data sets A and B, as indicated in decision block 92. The GM localPriority values are a per-port configuration setting used as a tie-breaker when selecting between clocks received on different ports within a single network element, with lower values indicating higher priority.

Next, the process 80 checks if the GM clockClass of clock A is 127 or less, as indicated in decision block 94. If so, the process 80 may end. This check can be crucial in some cases, because, in PTP, a clockClass value of 127 indicates that a clock is in holdover mode, meaning it has lost synchronization with its primary reference source and is relying on its internal oscillator to maintain time. Clocks with a clockClass less than 127 are considered to be synchronized to a valid time source and are therefore preferred over those in holdover mode. By performing this comparison, the BTCA ensures that clocks with active synchronization are prioritized as time sources, thereby enhancing the accuracy and stability of time distribution within the network.

Finally, the process 80 compares the GM clockIdentity values of the data sets A and B, as indicated in decision block 96, selecting the lower value or not selecting either clock. The GM clockldentity is a unique 64-bit identifier assigned to each clock, typically derived from the device's MAC address by inserting the hexadecimal value 0xFFFE in the middle, ensuring global uniqueness within the network.

By comparing the data sets A and B of two clocks, the process 80 ensures the most stable and accurate clock is selected as the Best Time Transmitter (BTT). This selection may be critical in maintaining network synchronization, particularly during degraded scenarios such as holdover. The BTCA's structured evaluation process mitigates the risks of propagating timing errors by avoiding the selection of clocks with inferior attributes. Unlike the Best Master Clock Algorithm (BMCA), which uses similar parameters but focuses on selecting a Grandmaster Clock (GMC) during normal operation, the BTCA is specifically designed for choosing between potential time sources, especially in scenarios where holdover or timing degradation occurs. The BTCA's emphasis on a thorough, parameter-driven comparison provides enhanced stability in complex networks such as those operating under PTS.

An advantage of the process 80 is that it will work in the network 10, 30, 50 where third party devices are connected without causing any interoperability issues. That is, the process 80 works in the network 10, 30, 50 where some of the devices do not support the process 80. Here, those non-supportive devices can use the BTCA process in ITU-T Recommendation G.8275.2, Amendment 1, FIG. 3, omitting decision block 88, allowing all nodes or devices in the networks 10, 30, 50 to provide a selection of the BTT. The devices that support the process 80 will advantageously make a better selection resulting in longer holdover support.

Network Element with Synchronization Recovery

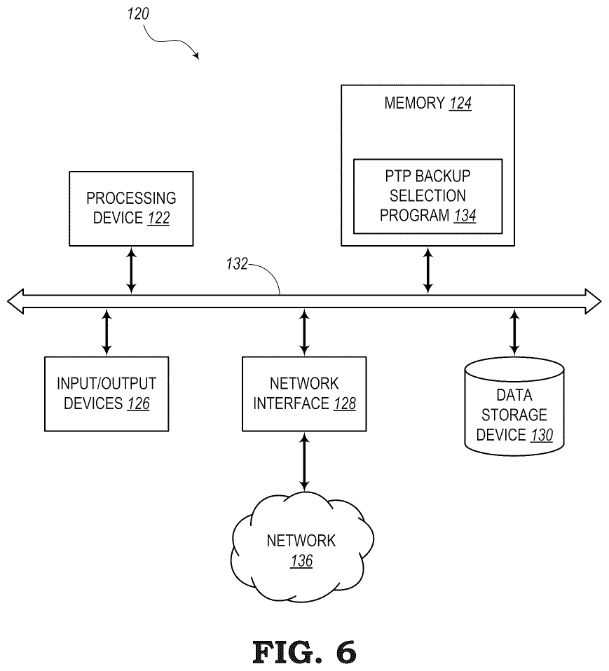

FIG. 6 is a block diagram illustrating an embodiment of a network element 120 configured to operate in a communications network, which may include a mobile or cellular system. The network element 120 may represent any of the node, components, or elements shown in FIGS. 1-3, such as the PRTC 12, T-GM 14, T-TSC-A 18, local time reference 20, 40, 60, T-GM 32, 52, component of the IP network 34, 54, T-BC-A 36, 56, servo 38, 58, etc. In some embodiments, the network element 120 may be a T-BC-A having multiple servos for analyzing multiple data sets representing the state of clock elements that may be used as substitute clock sources in the event that a primary clock source becomes unavailable due to any number of possible scenarios.

As shown in the embodiment of FIG. 6, the network element 120 is implemented as a computing device and includes a processing device 122, memory 124, input/output devices 126 (or I/O interfaces), a network interface 128, and a data storage device 130. The processing device 122 may be integrated within the network element 120 or function as a standalone unit connected to the network element 120. It may also be known as an apparatus, a control module, shelf controller, shelf processor, or system controller. The core of the network element 120 may include a processing unit, such as a hardware unit that runs software instructions. The processing unit could be one or more custom or commercially available processors. During operation, the processing unit may execute software from memory 124, manage data communication with the memory 124, and control operations of the network element 120 based on the software.

The network interface 128, possibly an Ethernet device, allows the network element 120 to communicate over a data network and includes necessary connections for address, control, and data communication. The data storage device 130 stores various types of data such as telemetry data, Operations, Administration, Maintenance, and Provisioning (OAM&P) data, etc., and may include both volatile (e.g., RAM) and nonvolatile (e.g., ROM, hard drives) memory elements. Similarly, the memory 124 includes volatile and nonvolatile storage media, potentially employing a distributed architecture where components are located remotely but accessible by the processing device 122. The I/O interface facilitates communication between the network element 120 and external devices.

Those skilled in the art will recognize that the various embodiments may include processing circuitry of various types. The processing circuitry might include, but are not limited to, general-purpose microprocessors; Central Processing Units (CPUs); Digital Signal Processors (DSPs); specialized processors such as Network Processors (NPs) or Network Processing Units (NPUs), Graphics Processing Units (GPUs); Field Programmable Gate Arrays (FPGAs); Programmable Logic Device (PLD), or similar devices. The processing circuitry may operate under the control of unique program instructions stored in their memory (software and/or firmware) to execute, in combination with certain non-processor circuits, either a portion or the entirety of the functionalities described for the methods and/or systems herein. Alternatively, these functions might be executed by a state machine devoid of stored program instructions, or through one or more Application-Specific Integrated Circuits (ASICs), where each function or a combination of functions is realized through dedicated logic or circuit designs. Naturally, a hybrid approach combining these methodologies may be employed. For certain disclosed embodiments, a hardware device, possibly integrated with software, firmware, or both, might be denominated as circuitry, logic, or circuits “configured to” or “adapted to” execute a series of operations, steps, methods, processes, algorithms, functions, or techniques as described herein for various implementations.

Additionally, some embodiments may incorporate a non-transitory computer-readable storage medium that stores computer-readable instructions for programming any combination of a computer, server, appliance, device, module, processor, or circuit (collectively “system”), each equipped with processing circuitry. These instructions, when executed, enable the system to perform the functions as delineated and claimed in this document. Such non-transitory computer-readable storage mediums can include, but are not limited to, hard disks, optical storage devices, magnetic storage devices, Read-Only Memory (ROM), Programmable Read-Only Memory (PROM), Erasable Programmable Read-Only Memory (EPROM), Electrically Erasable Programmable Read-Only Memory (EEPROM), Flash memory, etc. The software, once stored on these mediums, includes executable instructions that, upon execution by one or more processors or any programmable circuitry, instruct the processor or circuitry to undertake a series of operations, steps, methods, processes, algorithms, functions, or techniques as detailed herein for the various embodiments.

Furthermore, the network element 120 includes a PTP backup selection program 134, which may be implemented in any suitable combination of hardware and/or software. For instance, the PTP backup selection program 134 may be stored as computer logic in the memory 124 or other suitable non-transitory computer-readable media and may have instructions allowing the processing device 122 to perform certain procedures related to selecting a backup clock source as a substitute when it is determined that a primary source is temporarily unavailable.

In some embodiments, the PTP backup selection program 134 may enable the network element 120, while operating in a network 136, to obtain multiple data sets representing multiple backup clocks. In response to detecting that a primary source of synchronization for the communications network is unavailable, the PTP backup selection program 134 may enable the network element 120 to analyze offset characteristics of the multiple backup clocks in order to select a substitute clock source from the multiple backup clocks to operate as a temporary substitute for the primary source. For each backup clock, the offset characteristics are configured to be related to a synchronization offset of the associated backup clock with respect to the primary source (e.g., as illustrated in FIG. 4).

According to additional embodiments, each of the multiple data sets may include data points representing the synchronization offset of the associated backup clock with respect to the primary source over time. For example, the data points of each of the data sets may be plottable as a waveform (e.g., waveforms 74, 76). Also, a variability factor may be defined as a peak-to-peak value (e.g., 74b, 76b) of the associated waveform. In this case, it is compared with the variability factor of other data sets to select the substitute clock source from a backup clock of the multiple backup clocks having the lowest peak-to-peak value. In alternative embodiments, the variability factor may be defined as an average value (e.g., 74a, 76a) or median value of the associated waveform. In this case, it is compared with the variability factor of other data sets to select the substitute clock source from a backup clock of the multiple backup clocks having the lowest average value or median value.

The network element of claim 1, wherein each of the multiple data sets includes data points representing the synchronization offset of the associated backup clock with respect to the primary source over a most recent time period of predetermined length. The network element of claim 4, wherein the predetermined length is about 24 hours. The network element of claim 1, wherein, before detecting that the primary source is unavailable, the circuitry is further configured to continuously calculate the offset characteristics to determine substantially in real-time a best clock source selection for operation as the substitute clock when the primary source is unavailable.

The network element of claim 1, wherein the multiple backup clocks include two or more Precision Time Protocol over Internet Protocol (PTP over IP) sources. The network element of claim 1, wherein the communications network includes at least a mobile network having radios and Base Band Units (BBUs). The network element of claim 1, wherein the primary source of synchronization includes a clock reference from a Global Navigation Satellite System (GNSS). The network element of claim 1, wherein selection of the substitute clock source is an enhancement to one or more standards or protocols defined in IEEE 1588, Precision Time Protocol (PTP), ITU-T recommendations regarding clock synchronization, and/or ITU-T recommendations regarding Assisted Partial Timing Support (APTS). The network element of claim 1, wherein the network element is a Telecom-Boundary Clock-Assisted (T-BC-A) device having multiple servos configured to receive the multiple data sets.

### Process for Selecting a Backup Clock Source

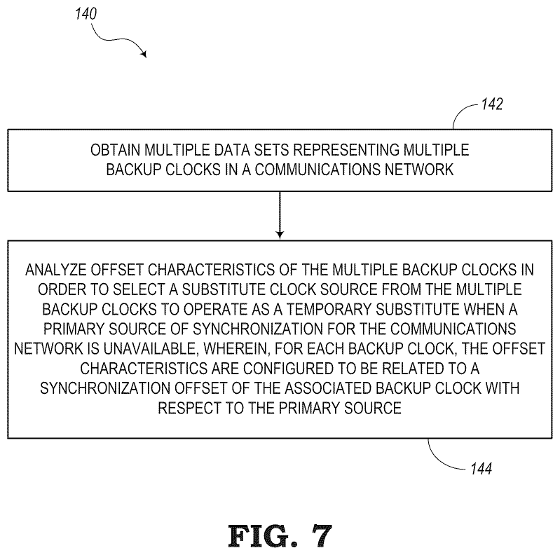

FIG. 7 is a flow diagram illustrating a method 140 for selecting a backup clock source. As shown in this embodiment, the method 140 includes a step of obtaining multiple data sets representing multiple backup clocks, as indicated in block 142. As indicated in block 144, the method 140 further includes a step of analyzing offset characteristics of the multiple backup clocks in order to select a substitute clock source from the multiple backup clocks to operate as a temporary substitute when a primary source of synchronization for the communications network is unavailable. For each backup clock, the offset characteristics are configured to be related to a synchronization offset of the associated backup clock with respect to the primary source.

According to additional embodiments, each of the multiple data sets may include data points representing the synchronization offset of the associated backup clock with respect to the primary source over time. For example, the data points of each of the data sets may be plottable as a waveform (e.g., waveforms 74, 76). Also, a variability factor may be defined as a peak-to-peak value (e.g., 74b, 76b) of the associated waveform. In this case, it is compared with the variability factor of other data sets to select the substitute clock source from a backup clock of the multiple backup clocks having the lowest peak-to-peak value. In alternative embodiments, the variability factor may be defined as an average value (e.g., 74a, 76a) or median value of the associated waveform. In this case, it is compared with the variability factor of other data sets to select the substitute clock source from a backup clock of the multiple backup clocks having the lowest average value or median value.

In some embodiments, each of the multiple data sets may include data points representing the synchronization offset of the associated backup clock with respect to the primary source over a most recent time period of predetermined length. For example, the predetermined length may be about 24 hours. Before detecting that the primary source is unavailable, the method 140 may further include a step of continuously calculating the offset characteristics to determine, substantially in real-time, a best clock source selection for operation as the substitute clock when the primary source is unavailable.

The multiple backup clocks, for example, may include two or more Precision Time Protocol over Internet Protocol (PTP over IP) sources. The communications network associated with the method 140 may include at least a mobile network having radios, Base Band Units (BBUs), eNodeB components, towers, satellites, etc. The primary source of synchronization, as described herein, may be a clock reference from a Global Navigation Satellite System (GNSS). In some embodiments, selection of the substitute clock source may be an enhancement to one or more standards or protocols defined in IEEE 1588, Precision Time Protocol (PTP), ITU-T recommendations regarding clock synchronization, and/or ITU-T recommendations regarding Assisted Partial Timing Support (APTS). Also, in some cases, a network element that implements the method 140 may be a Telecom-Boundary Clock-Assisted (T-BC-A) device having multiple servos configured to receive the multiple data sets.

### ADDITIONAL CONSIDERATIONS

It may be noted that the novelty of the various embodiments of the present disclosure may be associated with calculation of asymmetry values, variation values, variability values, synchronization offset values, or the like, whereby an offset in clock synchronization of potential backup clocks are analyzed with respect to a grandmaster clock source or other suitable primary clock source. Two (or more) PTP sources may be compared via their respective servo instances running in parallel. Then, consideration of some variability factor (e.g., peak-to-peak asymmetry or variation) in the BTCA is used to select the best available backup at run time.

The systems and methods of the present disclosure may be based on a) two or more inputs that can be simultaneously fed to the BTCA, whereby the timestamps to their respective servo instances can be used to calculate their offset with respect to the local GNSS. In the case where both the PTP sources have the same clock quality parameters, the systems and methods of the present disclosure may further be based on b) the selection of the PTP backup based upon their offset variation with respect to the local GNSS over a certain time period (e.g., over the last 24 hours). This would lead to the selection of a more stable PTP as the backup to the GNSS.

Furthermore, the present disclosure has certain benefits with respect to traditional systems for providing synchronization source backups. For example, in some deployments, it has been noted that some of the PTP backups on the APTS nodes perform very poorly, such as in cases where their asymmetry variation was very close to the 1100 ns threshold. In the conventional systems, there was a possibility of losing synchronization lock after they become active after the GNSS failure, leading to delays and other issues in the network. These backups, which may have otherwise been selected in conventional systems, are analyzed as described in the current implementations to position an APTS solution which selects the most stable PTP as the backup and remains reliable after the GNSS failure.

A Telecom Grandmaster (T-GM) may be configured as a specialized grandmaster clock used in telecommunications networks that implement PTP. Specifically defined in recommendations like ITU-T G.8275.1 and G.8275.2, the T-GM serves as the primary source of precise time and phase synchronization for telecom networks requiring high levels of accuracy. In the context of PTP, the T-GM may be configured to distribute accurate timing information to downstream network elements, such as Telecom Boundary Clocks (T-BCs) and Telecom Time Slave Clocks (T-TSCs). The T-GM may be configured to interface with a highly accurate reference time source, typically a Global Navigation Satellite System (GNSS), such as GPS. The T-GM may then use PTP to propagate this timing information across the network, ensuring that all devices are synchronized to the same precise time. The T-GM is designed to meet the stringent synchronization requirements of modern telecom applications, such as 4G LTE-Advanced and 5G networks.

The BTCA in ITU-T G.8275.2 plays a vital role in ensuring robust time synchronization in networks with Partial Timing Support (PTS). G.8275.2 addresses scenarios where not all network elements provide full timing support, i.e., the PTS, making it more challenging to maintain synchronization accuracy. The BTCA is designed to select the Best Time Transmitter (BTT) among multiple PTP clocks available in the network 10. It evaluates various parameters, such as those contained in PTP Announce messages, including clock priority, clock quality, and stability, to determine the most reliable source of timing. In a PTS environment, where some nodes may lack full synchronization support, the BTCA ensures that nodes can make informed decisions about which time source to use. Unlike the Best Master Clock Algorithm (BMCA), the BTCA incorporates a stronger focus on the quality of frequency backup and the reliability of timing inputs, which is critical for networks prone to disruptions or partial support scenarios. By selecting the most stable and accurate clock, the BTCA enhances the resilience of synchronization systems in G.8275.2 networks, ensuring continuity and precision in time distribution even when full timing support is unavailable. The Alternate Best Time Clock Algorithm (A-BTCA) is a variation of the BTCA designed to enhance timing resilience by incorporating additional criteria, such as topology awareness or specific network conditions, for selecting the Best Time Transmitter, whereas the standard BTCA primarily focuses on predefined parameters like clock quality and frequency backup, without accounting for network-specific factors.

With respect to the terms master and grandmaster, a grandmaster clock, e.g., the T-GM, is the primary source of time for the network. It is chosen based on its superior clock quality, stability, and attributes such as priority and accuracy. The grandmaster is responsible for providing the reference time to all other clocks in the network, which synchronize with it to maintain accurate timing. A master clock, on the other hand, is any clock in the network that is actively distributing timing information to other clocks (slaves) within its domain. While the grandmaster clock is always a master clock, not all master clocks are grandmaster clocks. For instance, in certain network configurations or holdover scenarios, a local node might become a master clock temporarily, distributing time to nearby devices even though it is not the primary reference (GMC). In BTCA, the distinction becomes significant during degraded scenarios or holdover periods. The algorithm may select a master clock to act as the active timing source based on its relative stability and quality in that specific context, even if it is not the original grandmaster. This ensures that timing accuracy is preserved as much as possible, especially in networks with Partial Timing Support (as in G.8275.2). Thus, while the grandmaster is the preferred ultimate time source, BTCA allows for flexibility in selecting an alternative master cock based on the best available timing conditions. The present disclosure addresses improvements in BTCA for selecting the master clock during disruptions to the grandmaster, for purposes of improving holdover.

In the network, the T-GMs and the T-BCs may be located at nodes or network elements and/or links interconnecting the nodes or network elements. The T-BCs may have a backup local Synchronous Ethernet (SyncE) clock other than its congruent primary PTP connection to the T-GM, thus if the T-BC loses the PTP connection (e.g., due to degradation or other cause), it still has its Primary Reference Clock (PRC) traceable to the SyncE clock. However, as mentioned throughout the present disclosure, the conventional BTCA does not normally check variability factors (e.g., peak-to-peak variability of a waveform created by data points over time).

### CONCLUSION

In this disclosure, including the claims, the phrases “at least one of” or “one or more of” when referring to a list of items mean any combination of those items, including any single item. For example, the expressions “at least one of A, B, or C,” “at least one of A, B, and C,” “one or more of A, B, or C,” and “one or more of A, B, and C” cover the possibilities of: only A, only B, only C, a combination of A and B, A and C, B and C, and the combination of A, B, and C. This can include more or fewer elements than just A, B, and C. Additionally, the terms “comprise,” “comprises,” “comprising,” “include,” “includes,” and “including” are intended to be open-ended and non-limiting. These terms specify essential elements or steps but do not exclude additional elements or steps, even when a claim or series of claims includes more than one of these terms.

Although operations, steps, instructions, blocks, and similar elements (collectively referred to as “steps”) are shown or described in the drawings, descriptions, and claims in a specific order, this does not imply they must be performed in that sequence unless explicitly stated. It also does not imply that all depicted operations are necessary to achieve desirable results. In the drawings, descriptions, and claims, extra steps can occur before, after, simultaneously with, or between any of the illustrated, described, or claimed steps. Multitasking, parallel processing, and other types of concurrent processing are also contemplated. Furthermore, the separation of system components or steps described should not be interpreted as mandatory for all implementations; also, components, steps, elements, etc. can be integrated into a single implementation or distributed across multiple implementations.

While this disclosure has been detailed and illustrated through specific embodiments and examples, it should be understood by those skilled in the art that numerous variations and modifications can perform equivalent functions or achieve comparable results. Such alternative embodiments and variations, even if not explicitly mentioned but that achieve the objectives and adhere to the principles disclosed herein, fall within the spirit and scope of this disclosure. Accordingly, they are envisioned and encompassed by this disclosure and are intended to be protected under the associated claims. In other words, the present disclosure anticipates combinations and permutations of the described elements, operations, steps, methods, processes, algorithms, functions, techniques, modules, circuits, and so on, in any conceivable order or manner-whether collectively, in subsets, or individually-thereby broadening the range of potential embodiments.

What is claimed is:

1. A network element configured to operate in a communications network, the network element comprising circuitry configured to:
obtain multiple data sets representing multiple backup clocks; and
analyze offset characteristics of the multiple backup clocks in order to select a substitute clock source from the multiple backup clocks to operate as a temporary substitute when a primary source of synchronization for the communications network is unavailable;
wherein, for each backup clock, the offset characteristics are related to a synchronization offset of an associated backup clock with respect to the primary source.

2. The network element of claim 1, wherein each of the multiple data sets includes data points representing the synchronization offset of the associated backup clock with respect to the primary source over time, wherein the data points of each of the data sets are plottable as a waveform, and wherein a variability factor, defined as a peak-to-peak value of the associated waveform, is compared with the variability factor of other data sets to select the substitute clock source from a backup clock of the multiple backup clocks having the lowest peak-to-peak value.

3. The network element of claim 1, wherein each of the multiple data sets includes data points representing the synchronization offset of the associated backup clock with respect to the primary source over time, wherein the data points of each of the data sets are plottable as a waveform, and wherein a variability factor, defined as an average value or median value of the associated waveform, is compared with the variability factor of other data sets to select the substitute clock source from a backup clock of the multiple backup clocks having a lowest average value or median value.

4. The network element of claim 1, wherein each of the multiple data sets includes data points representing the synchronization offset of the associated backup clock with respect to the primary source over a most recent time period of predetermined length.

5. The network element of claim 4, wherein the predetermined length is about 24 hours.

6. The network element of claim 1, wherein, before detecting that the primary source is unavailable, the circuitry is further configured to continuously calculate the offset characteristics to determine substantially in real-time a best clock source selection for operation as the substitute clock source in anticipation of the primary source being unavailable.

7. The network element of claim 1, wherein the multiple backup clocks include two or more Precision Time Protocol over Internet Protocol (PTP over IP) sources.

8. The network element of claim 1, wherein the communications network includes at least a mobile network having radios and Base Band Units (BBUs).

9. The network element of claim 1, wherein the primary source of synchronization includes a clock reference from a Global Navigation Satellite System (GNSS).

10. The network element of claim 1, wherein selection of the substitute clock source is an enhancement to one or more standards or protocols defined in IEEE 1588, Precision Time Protocol (PTP), ITU-T recommendations regarding clock synchronization, and/or ITU-T recommendations regarding Assisted Partial Timing Support (APTS).

11. The network element of claim 1, wherein the network element is a Telecom-Boundary Clock-Assisted (T-BC-A) device having multiple servos configured to receive the multiple data sets.

12. A method comprising steps of:
obtaining multiple data sets representing multiple backup clocks in a communications network; and
analyzing offset characteristics of the multiple backup clocks in order to select a substitute clock source from the multiple backup clocks to operate as a temporary substitute when a primary source of synchronization for the communications network is unavailable;
wherein, for each backup clock, the offset characteristics are related to a synchronization offset of an associated backup clock with respect to the primary source.

13. The method of claim 12, wherein each of the multiple data sets includes data points representing the synchronization offset of the associated backup clock with respect to the primary source over time, wherein the method further comprises steps of:
plotting the data points of each of the data sets as a waveform;
calculating a variability factor for each data set, the variability factor defined as a peak-to-peak value of the associated waveform; and
comparing the variability factor of the multiple data sets to select the substitute clock source from a backup clock of the multiple backup clocks having the lowest peak-to-peak value.

14. The method of claim 12, wherein each of the multiple data sets includes data points representing the synchronization offset of the associated backup clock with respect to the primary source over time, wherein the method further comprises steps of:
plotting the data points of each of the data sets as a waveform;
calculating a variability factor for each data set, the variability factor defined as an average value or median value of the associated waveform; and
comparing the variability factor of the multiple data sets to select the substitute clock source from a backup clock of the multiple backup clocks having the lowest average value or median value.

15. The method of claim 12, wherein each of the multiple data sets includes data points representing the synchronization offset of the associated backup clock with respect to the primary source over a most recent time period of predetermined length.

16. The method of claim 12, wherein, before detecting that the primary source is unavailable, the method includes a step of continuously calculating the offset characteristics to determine substantially in real-time a best clock source selection for operation as the substitute clock source in anticipation of the primary source being unavailable.

17. The method of claim 12, wherein the multiple backup clocks include two or more Precision Time Protocol over Internet Protocol (PTP over IP) sources.

18. The method of claim 12, wherein the communications network includes at least a mobile network having radios and Base Band Units (BBUs), and wherein the primary source of synchronization includes a clock reference from a Global Navigation Satellite System (GNSS).

19. A Telecom-Boundary Clock-Assisted (T-BC-A) device operating in a communications network, the T-BC-A device comprising:
a processing device; and
memory configured to store computer logic having instructions that, when executed, enable the processing device to
obtain multiple data sets representing multiple backup clocks, and
analyze offset characteristics of the multiple backup clocks in order to select a substitute clock source from the multiple backup clocks to operate as a temporary substitute when a primary source of synchronization for the communications network is unavailable;
wherein, for each backup clock, the offset characteristics are related to a synchronization offset of an associated backup clock with respect to the primary source.

20. The T-BC-A device of claim 19, wherein selection of the substitute clock source is an enhancement to one or more standards or protocols defined in IEEE 1588, Precision Time Protocol (PTP), ITU-T recommendations regarding clock synchronization, and/or ITU-T recommendations regarding Assisted Partial Timing Support (APTS).
